(19) United States
(12) Patent Application Publication
(10) Pub. No.: US 2010/0166444 A1
(43) Pub. Date: Jul. 1, 2010

(54) IMAGE FORMING APPARATUS AND IMAGE FORMING METHOD

(75) Inventors: Yujiro NOMURA, Shiojiri-shi (JP); Ken IKUMA, Suwa-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/642,654

(22) Filed: Dec. 18, 2009

(30) Foreign Application Priority Data
Dec. 26, 2008 (JP) 2008-333115

(51) Int. Cl. G03G 15/043

(52) U.S. Cl. 399/51; 399/83

(57) ABSTRACT

An image forming apparatus includes: a latent image carrier which carries a latent image; an exposure head which exposes the latent image carrier to light emitted from a light emitting element; a driver which rotationally drives the latent image carrier; a light emission controller which controls light emission time of the light emitting element; a rotational angle detector which detects a rotational angle of the latent image carrier; and a memory which stores first light emission time correction information to correct the light emission time in response to an eccentricity of the latent image carrier. The light emission controller permits the light emitting element to emit light at the light emission time corrected on the basis of a detection result of the rotational angle detector and the first light emission time correction information.

### BACKGROUND

1. Technical Field

The present invention relates to a technique capable of exposing a latent image carrier to light of a light emission element.

2. Related Art

In the past, there was known an image forming apparatus which permits a light emission element to emit light at a time, at which the circumferential surface of a photoconductive drum rotates, to expose the circumferential surface of the photoconductive drum, while rotatably driving the photoconductive drum. The image forming apparatus is mounted with a driving system which rotatably drives the photoconductive drum. As disclosed in JP-A-9-182488, however, a driving speed of the driving system may be changed. When the driving speed is changed, the angular velocity of the photoconductive drum may also be changed. The velocity of the circumferential surface of the photoconductive drum is given by the product of a distance between a rotational center and the circumferential surface and an angular velocity. Therefore, when the angular velocity is changed, as described above, the velocity (the circumferential velocity of the photoconductive drum) of the photoconductive drum is also changed. As a consequence, since an exposure position of the light emission element is deviated on the circumferential surface of the photoconductive drum, a problem arises in that a good exposure operation may not be performed.

Moreover, the change in the circumferential velocity of a latent image carrier such as a photoconductive drum is caused not only by the change in the angular velocity of the latent image carrier but also by eccentricity of the latent image carrier in some cases. That is, when the eccentricity of the latent image carrier is caused, the distance between the rotational center and the circumferential surface of the latent image carrier is changed at the position on the circumferential surface of the latent image carrier. As a consequence, the circumferential velocity may be faster at a position distant from the rotational center and the circumferential velocity may be slower at a position close to the rotational center. In addition, when the circumferential velocity of the latent image carrier is changed by the eccentricity of the latent image carrier, the exposure position of the light emission element is deviated on the circumferential surface of the latent image carrier. Therefore, a problem arises in that a good exposure operation may not be performed.

In order to realize a good exposure operation by controlling the exposure position of the light emission element with high precision, as known from the above description, it is important to inhibit the influence of both the change in the angular velocity of the latent image carrier and the eccentricity of the latent image carrier on the exposure position of the light emission element.

### SUMMARY

An advantage of some aspects of the invention is that it provides a technique capable of realizing a good exposure operation by controlling the exposure position of a light emission element with high precision without the influence of a change in the angular velocity of a latent image carrier and the eccentricity of the latent image carrier.

According to an aspect of the invention, there is provided an image forming apparatus including: a latent image carrier which carries a latent image; an exposure head which exposes the latent image carrier to light emitted from a light emitting element; a driver which rotationally drives the latent image carrier; a light emission controller which controls light emission time of the light emitting element; a rotational angle detector which detects a rotational angle of the latent image carrier; and a memory which stores first light emission time correction information to correct the light emission time in response to an eccentricity of the latent image carrier. The light emission controller permits the light emitting element to emit light at the light emission time corrected on the basis of a detection result of the rotational angle detector and the first light emission time correction information.

According to another aspect of the invention, there is provided an image forming method including: detecting a rotation angle of a latent image carrier which is rotationally driven; and exposing the latent image carrier to light emitted from a light emitting element. The exposing includes reading from a memory first light emission time correction information to correct light emission time in response to an eccentricity of the latent image carrier, and permitting the light emitting element to emit light at the light emission time corrected on the basis of a detection result from the detecting of the rotation angle and the first light emission time correction information.

According to the aspects of the invention (the image forming apparatus and the image forming method), the rotational angle of the latent image carrier is detected (the rotational angle detector and the detecting of the rotational angle). Accordingly, by correcting the light emission time on the basis of the detection result, it is possible to inhibit a difference in the exposure position of the light emission element caused by the variation in the angular velocity of the latent image carrier. However, in order to perform the above-described good exposing operation, it is necessary to consider the influence of the eccentricity of the latent image carrier on the exposure position. According to the aspects of the invention, the memory stores the first light emission time correction information to correct the light emission time in response to the eccentricity of the latent image carrier. According to the aspects of the invention, the light emission time is corrected on the basis of not only the detection result of the rotational angle but also the first light emission time correction information, and the light emission element emits light at the corrected light emission time. In this way, by controlling the exposure position of the light emission element without the influence of the variation in the angular velocity of the latent image carrier and the eccentricity of the latent image carrier, it is possible to realize the good exposing operation.

The light emission controller may obtain second light emission correction information to correct the light emission time from the detection result of the rotational angle detector in response to a variation in the angular velocity of the latent image carrier, and may correct the light emission time on the basis of the first light emission time correction information and the second light emission time correction information. Even with such a configuration, by controlling the exposure position of the light emission element with high precision without the influence of the variation in the angular velocity of the latent image carrier and the eccentricity of the latent image carrier, it is possible to realize the good exposing operation.

In the image forming apparatus according to the above aspect of the invention, the latent image carrier may be a photoconductive drum having a rotational shaft, and the driver may rotationally drive the rotational shaft. This is because, in such an image forming apparatus, the angular velocity of the latent image carrier may vary due to an irregular driving speed of the driver, the rotational shaft of the photoconductive drum becomes eccentric, and thus the circumferential velocity of the latent image carrier may vary.

The rotational angle detector may be an encoder disposed on the rotational shaft of the photoconductive drum. By disposing the encoder on the rotational shaft of the photoconductive drum, the encoder can detect the rotational angle of the photoconductive drum.

The photoconductive drum may be disposed in a cartridge which is detachably mounted in the image forming apparatus and holds the photoconductive drum. With such a configuration, the cartridge is replaced, as necessary, to maintain the image forming apparatus. When the photoconductive drum is replaced with a new photoconductive drum in the replacement of the cartridge, it is necessary to adjust the first light emission time correction information to the eccentricity of the new photoconductive drum. In this case, the memory storing the first light emission time correction information may be disposed in the cartridge. With such a configuration, the memory stores the first light emission time correction information corresponding to the eccentricity of the photoconductive drum in shipment of the cartridge from a factory. Then, when the photoconductive drum is replaced with a new photoconductive drum in the replacement of the cartridge, the first light emission time correction information can be adjusted to information corresponding to the replaced photoconductive drum. That is, even when extra work is not carried out in the replacement of the cartridge, the first light emission time correction information can be adjusted to an appropriate value, thereby realizing an appropriate configuration.

In the configuration where the memory is disposed in the cartridge, the memory may be a non-volatile memory.

### BRIEF DESCRIPTION OF THE DRAWINGS

The invention will be described with reference to the accompanying drawings, wherein like numbers reference like elements.

FIG. 1 is a diagram illustrating an image forming apparatus according to an embodiment.

FIG. 2 is a diagram illustrating the electric configuration of the image forming apparatus in FIG. 1.

FIG. 3 is a partially perspective view illustrating the configuration of a line head.

FIG. 4 is a partially sectional view illustrating the line head in a width direction of the line head.

FIG. 5 is a diagram illustrating a case where the eccentricity of a photoconductive drum has an influence on the circumferential velocity of the photoconductive drum.

FIG. 6 is a perspective view illustrating the configuration of a light emission element to control light emission time.

FIG. 7 is a side view illustrating the configuration of the light emission element to control the light emission time.

FIGS. 8A to 8D are diagrams illustrating an operation of correcting a horizontal request signal.

FIG. 9 is a time chart illustrating an example of the operation of correcting the horizontal request signal.

FIG. 10 is a flowchart illustrating a method of calculating an “H-req correction value by an eccentric amount”.

FIG. 11 is a perspective view illustrating the operation performed in the flowchart of FIG. 10.

FIGS. 12A to 12D are diagrams illustrating an example of each value calculated in the flowchart of FIG. 10.

FIG. 13 is a table illustrating a table of the “H-req correction value by an eccentric amount” according to a modified example.

FIGS. 14A to 14D are diagrams illustrating an example of the invention.

### DESCRIPTION OF EXEMPLARY EMBODIMENTS

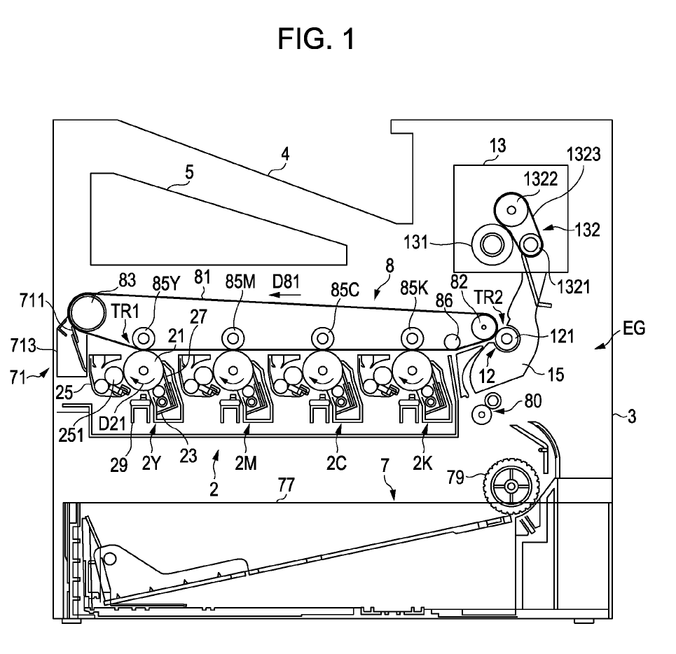

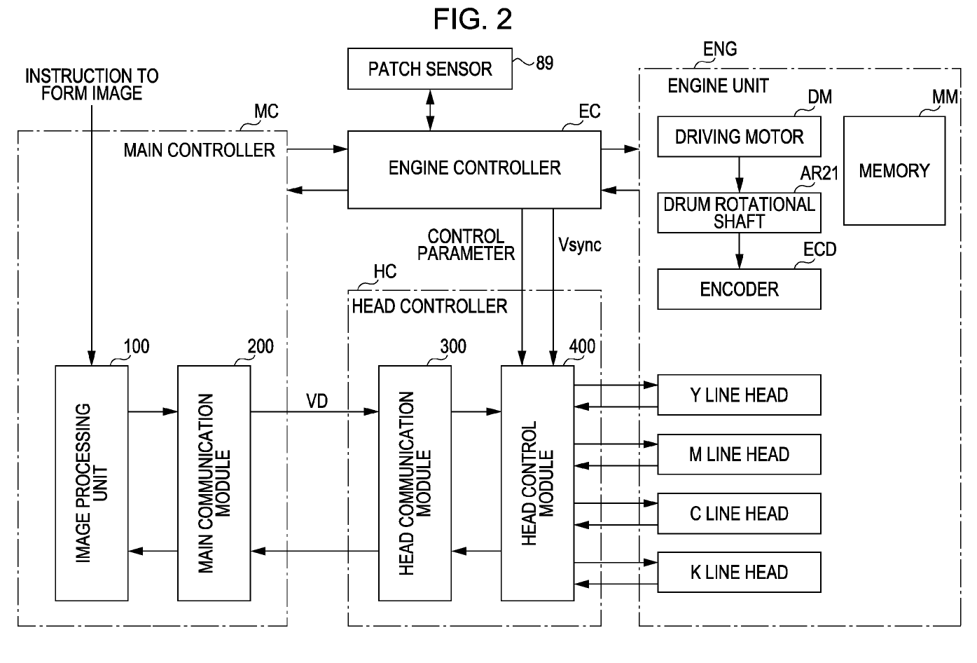

FIG. 1 is a diagram illustrating an image forming apparatus according to an embodiment of the invention. FIG. 2 is a diagram illustrating the electric configuration of the image forming apparatus in FIG. 1. The image forming apparatus is capable of selectively performing between a color mode, where toner of four colors, that is, yellow (Y) toner, magenta (M) toner, cyan (C) toner, and black (K) are superimposed to form a color image, and a black-and-white mode, where only black (K) toner is used to form a black-and-white image. In the image forming apparatus, when an image formation instruction is supplied from an external apparatus such as a host computer to a main controller MC including a CPU or a memory, the main controller MC supplies a control signal to an engine controller EC, the engine controller EC controls units such as an engine unit ENG and a head controller HC on the basis of the control signal to perform a predetermined image forming operation, and the image forming apparatus forms the image corresponding to the instruction to form the image on a sheet such as a copy sheet, a transfer sheet, or a print sheet such as a paper sheet or an OHP transparent sheet.

An electric component box 5 having a power circuit board, the main controller MC, the engine controller EC, and the head controller HC therein is disposed in a housing main body 3 of the image forming apparatus. An image forming unit 2, a transfer belt unit 8, and a feeding unit 7 are disposed in the housing main body 3. In FIG. 1, a secondary transfer unit 12, a fixing unit 13, and a sheet guide member 15 are disposed on the right side of the housing main body 3. The feeding unit 7 is detachably mounted in the housing main body 3. The feeding unit 7 and the transfer belt unit 8 can be detached to be repaired or replaced.

The image forming unit 2 includes four image forming stations 2Y (yellow), 2M (magenta), 2C (cyan), and 2K (black) which form plural different color images, respectively. In FIG. 1, since the configurations of the image forming stations of the image forming unit 2 are the same as each other, reference numerals are given to only some of the image forming stations and no reference numerals are given to the other image forming stations for convenient illustration.

Each color toner image is formed on the surface of a photoconductive drum 21, which is installed in each of the image forming stations 2Y, 2M, 2C, and 2K. Each photoconductive drum 21 is disposed such that a rotational shaft AR21 thereof is parallel or substantially parallel to a main scanning direction MD (which is perpendicular to the sheet surface of FIG. 1). The rotational shaft AR21 of each photoconductive drum 21 is connected to an exclusive-use driving motor DM and is rotatably driven at a predetermined velocity in a direction of an arrow D21 in the drawing. Accordingly, the surface of the photoconductive drum 21 is transported in a sub-scanning direction SD perpendicular to or substantially perpendicular to the main scanning direction MD. Around the circumferential surface of each photoconductive drum 21, a charging unit 23, a line head 29, a development unit 25, and a photoconductive cleaner 27 are disposed along the rotation direction. These units perform a charging operation, a latent image forming operation, a toner development operation. Upon performing the color mode, a color image is formed by superimposing the toner images formed by all of the image forming stations 2Y, 2M, 2C, and 2K on a transfer belt 81 disposed in the transfer belt unit 8. Upon performing the black-and-white mode, a black monochrome image is formed by operating only the image forming station 2K.

The charging unit 23 includes a charging roller of which the surface is made of elastic rubber. The charging roller is configured to come into contact with the surface of the photoconductive drum 21 at a charging position and to be rotatably driven. Therefore, the charging roller is rotatably driven with rotational operation of the photoconductive drum 21. Since the charging roller is connected to a charging bias generator (not shown), the charging roller receives a charging bias from the charging bias generator and charges the surface of the photoconductive drum 21 with a predetermined surface potential at the charging position where the photoconductive drum 21 comes into contact with the charging unit 23.

The line head 29 is disposed so that a longitudinal direction LGD thereof is parallel or substantially parallel to the main scanning direction MD and a width direction LTD thereof is parallel or substantially parallel to the sub-scanning direction SD. The line head 29 includes plural light emission elements arranged in the longitudinal direction LGD and is disposed so as to face the photoconductive drum 21. Light from the light emission elements is emitted to the surface of the photoconductive drum 21 charged by the charging unit 23 to form an electrostatic latent image.

The development unit 25 includes a development roller 251 supporting toner on the surface. By a development bias applied to the development roller 251 from a development bias generator (not shown) electrically connected to the development roller 251, charged toner is transferred from the development roller 251 to the photoconductive drum 21 and an electrostatic latent image formed on the surface of the photoconductive drum 21 is developed at the development position where the photoconductive drum 21 comes into contact with the development roller 251.

The toner image shown at the development position is transported in the rotational direction D21 of the photoconductive drum 21, and then is subjected to first transferring to the transfer belt 81 at a first transfer position TR1 where the photoconductive drum 21 comes into contact with the transfer belt 81.

A photoconductive cleaner 27 is installed on the downstream side of the first transfer position TR1 in the rotational direction D21 of the photoconductive drum 21 and on the upstream side of the charging unit 23 so as to come into contact with the surface of the photoconductive drum 21. The photoconductive cleaners 27 come into contact with the surface of the photoconductive drum 21 to clean the toner remaining on the surface of the photoconductive drum 21 after the first transfer.

The transfer belt unit 8 includes a driving roller 82, a driven roller 83 (blade facing roller) disposed on the left side of the driving roller 82 in FIG. 1, and the transfer belt 81 suspended on the rollers and circularly driven in a direction (transport direction) of an arrow D81 by the rotation of the driving roller 82. The transfer belt unit 8 includes four first transfer rollers 85Y, 85M, 85C, and 85K, which are disposed so as to face the photoconductive drums 21 of the image forming stations 2Y, 2M, 2C, and 2K, respectively, in a one-to-one manner upon mounting the cartridge, in the inward portion of the transfer belt 81. The first transfer rollers are electrically connected to first transfer bias generators (not shown), respectively.

Upon performing the color mode, the first transfer position TR1 is formed between the photoconductive drums 21 and the transfer belt 81 by positioning all of the first transfer rollers 85Y, 85M, 85C, and 85K to the image forming stations 2Y, 2M, 2C, and 2K and bringing the transfer belt 81 into press contact with the photoconductive drums 21 of the image forming stations 2Y, 2M, 2C, and 2K, as shown in FIGS. 1 and 2. By applying a first transfer bias from the first transfer bias generators to the first transfer roller 85Y and the like at appropriate times, the toner image formed on the surface of each photoconductive drum 21 is transferred to the surface of the transfer belt 81 at the first transfer position TR1. That is, in the color mode, respective monochrome color images are superimposed on the transfer belt 81 to form a color image.

The transfer belt unit 8 includes a downstream guide roller 86 disposed on the downstream side of the first transfer roller 85K for black and on the upstream side of the driving roller 82. The downstream guide roller 86 is configured to come into contact with the transfer belt 81 since the downstream guide roller 86 is disposed on the common tangent line between the first transfer roller 85K and the black photoconductive drum 21(K) at the first transfer position TR1 where the first transfer roller 85K comes into contact with the photoconductive drum 21 of the image forming station 2K.

Patch sensors 89 are disposed so as to face the surface of the transfer belt 81 wound around the downstream guide roller 86. The patch sensors 89 including a reflective photosensor, for example, detect the position, concentration, or the like of the patch image formed on the transfer belt 81, as necessary, by optically detecting a variation in the reflectance of the surface of the transfer belt 81.

The feeding unit 7 includes a feeder which has a feeding cassette 77 stacking and accommodating sheets and a pickup roller 79 feeding the sheets from the feeding cassette 77 one by one. The sheet fed from the pickup roller 79 of the feeder is fed along the sheet guide member 15 to a second transfer position TR2, where the driving roller 82 and a second transfer roller 121 come into contact with each other, after the feeding timing thereof is adjusted by a pair of register rollers 80.

The second transfer roller 121, which is disposed so as to separate from or come into contact with the transfer belt 81, is driven by a second transfer roller driving mechanism (not shown) so as to separate from or come into contact with the transfer belt 81. The fixing unit 13 includes: a heating roller 131 which has a heater such as a halogen heater therein and is rotatable; and a pressurizer 132 which pressurizes and urges the heating roller 131. The surface of the sheet on which an image is subjected to second transfer is guided to a nip section formed by the heating roller 131 and a pressurizing belt 1323 of the pressurizer 132 by the sheet guide member 15 and the image is heat-fixed at a predetermined temperature in the nip section. The pressurizer 132 includes two rollers 1321 and 1322 and the pressurizing belt 1323 suspended by these rollers. The loosed belt surface on the surface of the pressurizing belt 1323 is tightly pressed against the circumferential surface of the heating roller 131 by the two rollers 1321 and 1322, so that the nip section formed by the heating roller 131 and the pressurizing belt 1323 is configured to be broad. The sheet subjected to the heat-fixing is transported to a discharging tray 4 disposed on the surface of the housing main body 3.

The above-described driving roller 82 circularly drives the transfer belt 81 in the direction of the arrow D81 and also serves as a backup roller of the second transfer roller 121. A rubber layer with a thickness of about 3 mm and a volume resistivity of 1000 kΩ·cm or less is formed on the circumferential surface of the driving roller 82. By making ground through a metal shaft, a conductive path of a second transfer bias supplied from a second transfer bias generator (not shown) via the second transfer roller 121 is formed. In this way, by forming the rubber layer having a property of absorbing high friction or impact on the driving roller 82, it is possible to prevent deterioration in image quality caused due to transfer of the impact, which occurs when the sheet enters the second transfer position TR2, to the transfer belt 81.

In the image forming apparatus, a cleaner unit 71 is disposed so as to face the blade facing roller 83. The cleaner unit 71 includes a cleaner blade 711 and a waste toner box 713. The front end portion of the cleaner blade 711 comes into contact with the blade facing roller 83 with the transfer belt 81 interposed therebetween and removes foreign particles such as toner or sheet powder remaining on the transfer belt 81 after the second transfer. The moved foreign particles are collected in the waste toner box 713. The cleaner blade 711 and the waste toner box 713 are incorporated with the blade facing roller 83.

The photoconductive drum 21, the charging unit 23, the development unit 25, and the photoconductive cleaner 27 of each of the image forming stations 2Y, 2M, 2C, and 2K are incorporated as a cartridge unit. Each cartridge is configured to be detachably mounted in the apparatus main body. Each cartridge is mounted with a non-volatile memory storing information on the cartridge. Wireless communication is carried out between the engine controller EC and each cartridge. With such a configuration, the information on each cartridge is transmitted to the engine controller EC and information in each memory is updated and stored. The use history of each cartridge or the lifetime of consumables is managed on the basis of the information.

The main controller MC, the head controller HC, and each line head 29 are configured as different blocks and are connected to each other via serial communication lines. An operation of exchanging data between the blocks will be described with reference to FIG. 2. When the image formation instruction is supplied from an external apparatus to the main controller MC, the main controller MC transmits a control signal used to activate the engine unit ENG to the engine controller EC. An image processing unit 100 disposed in the main controller MC performs a predetermined signal processing operation on the image data contained in the image formation instruction and generates video data VD for each toner color.

On the other hand, the engine controller EC receiving the control signal performs initialization and warm-up of each unit of the engine unit ENG. When the initialization and the warm-up are completed and the image forming operation is ready to be performed, the engine controller EC outputs a synchronous signal Vsync starting the image forming operation to the head controller HC controlling each line head 29.

The head controller HC includes a head control module 400 controlling each line head and a head communication module 300 performing data communication with the main controller MC. On the other hand, the main controller MC also includes a main communication module 200. The main communication module 200 outputs the video data VD corresponding to one line to the head communication module 300, whenever the head communication module 300 requests the video data VD. The head communication module 300 transmits or receives the video data VD to or from the control module 400. The light emission element of each line head 29 emits light on the basis of the video data VD received from the head control module 400. As described below, light emission time of the light emission element is controlled on the basis of a horizontal request signal H-req. That is, the horizontal request signal H-req is a signal used to give the light emission time of the light emission element. The light emission element emits light in synchronization with the horizontal request signal H-req.

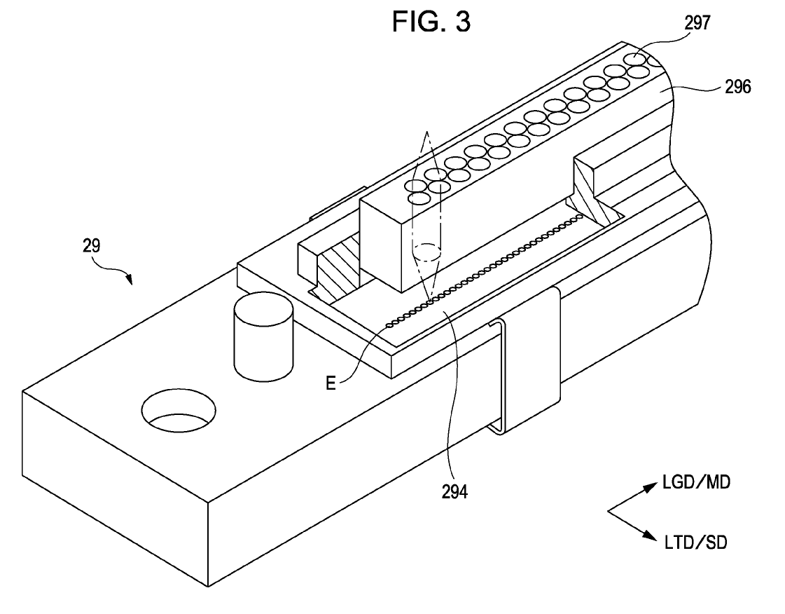

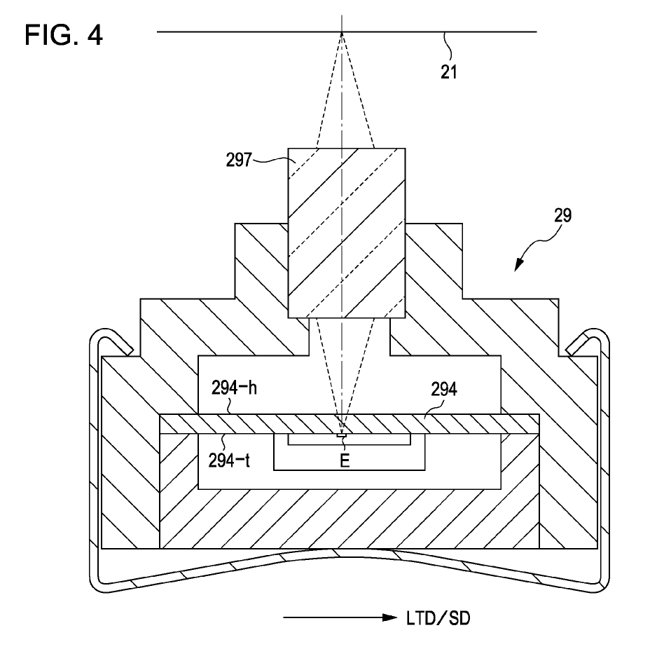

FIG. 3 is a partially perspective view illustrating the configuration of the line head. FIG. 4 is a partially sectional view illustrating the line head in a width direction of the line head. Since these drawings partially illustrate the line head, all parts of the line head are not shown. Plural light emission elements E are arranged in a longitudinal direction LGD at a pitch corresponding to the resolution on a rear surface 294-t of a head board 294 of the line head 29. Each light emission element E is an organic EL element formed on the rear surface 294-t and a so-called bottom emission type organic El element. A refractive index dispersion type rod lens array 297 is disposed so as to face a front surface 294-h of the head board 294. A light beam emitted from the light emission element E passes from the rear surface 294-t of the head board 294 to the front surface 294-h of the head board 294 and is imaged in an erected state by the rod lens array 297. In this way, a spot is formed on the surface of the photoconductive drum 21.

The image forming apparatus permits each light emission element E of the line head 29 to emit light at light emission time at which the surface of the photoconductive drum 21 moves in the sub-scanning direction SD to form a desired latent image on the surface of the photoconductive drum 21. At this time, as described above, the photoconductive drum 21 rotates by the rotational driving force of the driving motor DM mounted on the rotational shaft AR21. However, when the driving speed of the driving motor DM varies, the angular velocity of the photoconductive drum 21 may vary. As a consequence, the velocity (circumferential velocity) of the surface of the photoconductive drum 21 may vary. As described in detail below, the rotational shaft AR21 is eccentric from the center of the photoconductive drum 21 in some cases. In this case, the circumferential velocity of the surface of the photoconductive drum 21 may vary.

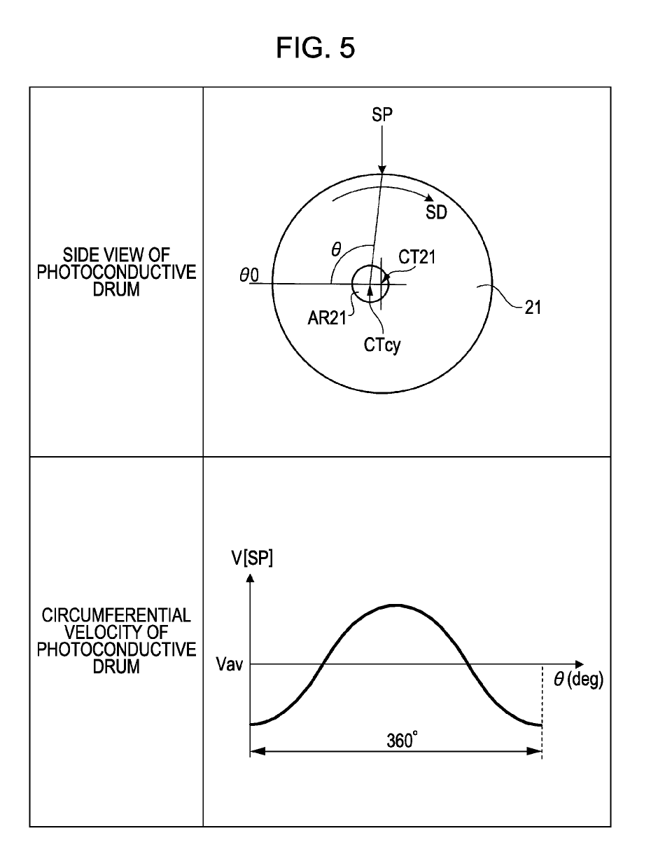

FIG. 5 is a diagram illustrating a case where the eccentricity of the photoconductive drum has an influence on the circumferential velocity of the photoconductive drum. In FIG. 5, part “side view of photoconductive drum” corresponds to a case where the photoconductive drum 21 is viewed from the longitudinal direction LGD. As shown in FIG. 5, a center CT21 of the photoconductive drum 21 is deviated from a center CTcy of the rotational shaft AR21, and thus the eccentricity of the photoconductive drum 21 occurs. When this eccentricity occurs, the distance between the center CTcy (rotational center) of the rotational shaft AR21 and the surface of the photoconductive drum 21 is changed at the position on the surface of the photoconductive drum 21. As a consequence, on the surface of the photoconductive drum 21, a circumferential velocity may become faster at a position distant from the rotation center CTcy and a circumferential velocity may become slower at a position close to the rotation center CTcy.

This state is shown in the graph shown in part “circumferential velocity of photoconductive drum”. The horizontal axis of the graph represents a rotational angle θ (degree) of the photoconductive drum 21 and the vertical axis represents a circumferential velocity V [SP] of the photoconductive drum 21. The rotational angle θ of the photoconductive drum 21 is an angle between the original point θ0 fixed on the photoconductive drum 21 and the formation position of the spot SP and has a value varying with the rotation of the photoconductive drum 21 (“side view of photoconductive drum”). A method of taking the original point θ0 is arbitrarily decided and the method of taking the original point θ0 in FIG. 5 is just an exemplary method. The graph shows the circumferential velocity at the formation position of the spot SP. As shown in the graph, the circumferential velocity of the photoconductive drum 21 varies on an average circumferential velocity Vav at a period of 360° (one rotational period of the photoconductive drum 21) due the eccentricity of the photoconductive drum 21. The variation in the circumferential velocity of the photoconductive drum 21 results in the difference in the exposure position of the line head 29 on the circumferential surface of the photoconductive drum 21.

In order to realize a good exposing operation by controlling the exposure position with high precision, it is important to inhibit the influence of both the variation in the angular velocity of the photoconductive drum 21 and the eccentricity of the photoconductive drum 21 on the exposure position. In this embodiment, in order to control the exposure position with high precision, the light emission time of the light emission element is controlled without the influence of the variation in the angular velocity of the photoconductive drum 21 and the eccentricity of the photoconductive drum 21.

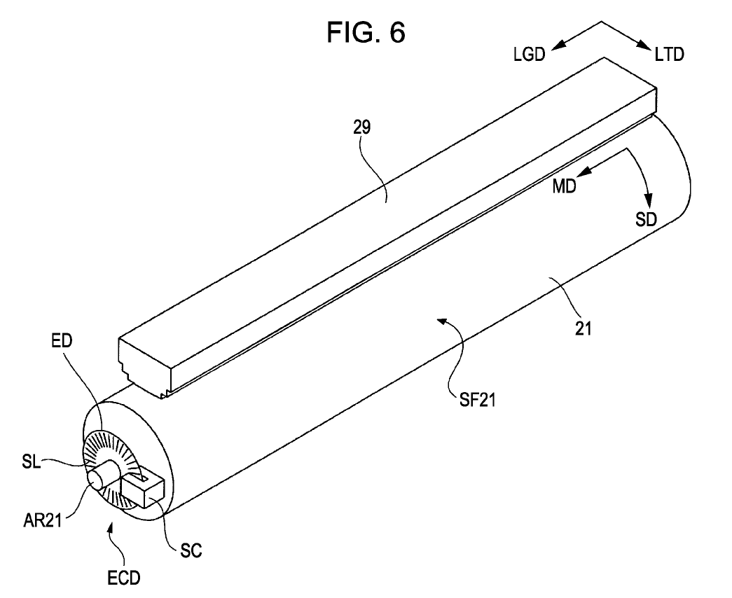

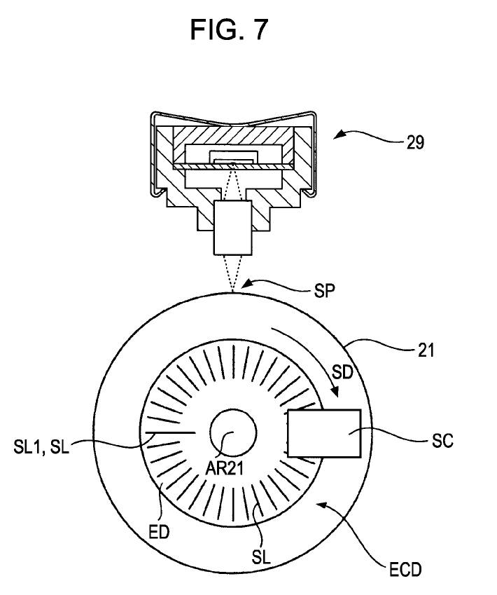

FIG. 6 is a perspective view illustrating the configuration of the light emission element to control the light emission time. FIG. 7 is a side view illustrating the configuration of the light emission element to control the light emission time. As shown in the drawings, an encoder ECD is mounted in one end portion of the rotational axis AR21 parallel or substantially parallel to the main scanning direction MD. The encoder ECD includes a disk-shaped encoder disk ED and a transmissive photosensor SC. The central portion of the encoder disk ED is mounted in the rotational shaft AR21 of the photoconductive drum 21 and the encoder disk ED is configured to be rotatable with the rotation of the photoconductive drum 21.

In the encoder disk ED, plural (64) line slits SL are formed in a radial shape about the rotational shaft AR21. A slit detection signal output by the photosensor SC detecting the slits SL is output to the engine controller EC. Among the 64 slits SL, a slit SL1 (reference slit SL1) located at the position corresponding to the original point θ0 (see FIG. 5) is longer than the other slits SL (SL2 to SL64). The slit detection signal of the reference slit SL1 is different from the slit detection signals of the slits SL (SL2 to SL64) other than the reference slit SL1. For this reason, the engine controller EC can detect the rotational angle θ of the photoconductive drum 21 by determining that a detection signal received from the photosensor SC is a signal output from whichever-numbered slit the slit distant from the reference slit SL1. In other words, the engine controller EC can detect the rotational angle θ at the reference slit SL1. The engine controller EC can also detect the angular velocity from a variation in the time of the rotational angle θ.

In this embodiment, the variation amount of the angular velocity of the photoconductive drum 21 is calculated from the detection result of the above-described slit SL, and an “H-req correction value AJv by a variation in the angular velocity” is calculated from the variation amount of the angular velocity. The “H-req correction value AJv by a variation in the angular velocity” is information used to correct the horizontal request signal H-req depending on the variation in the angular velocity of the photoconductive drum 21. An “H-req correction value AJd by an eccentric amount” stored in a memory MM is read. The “H-req correction value AJd by an eccentric amount” is information used to correct the horizontal request signal H-req depending on the eccentricity of the photoconductive drum 21. The horizontal request signal H-req is corrected on the basis of the “H-req correction value AJv by a variation in the angular velocity” and the “H-req correction value AJd by an eccentric amount”. In this way, the light emission time of the light emission element E is corrected. The correction of the light emission time will be described below.

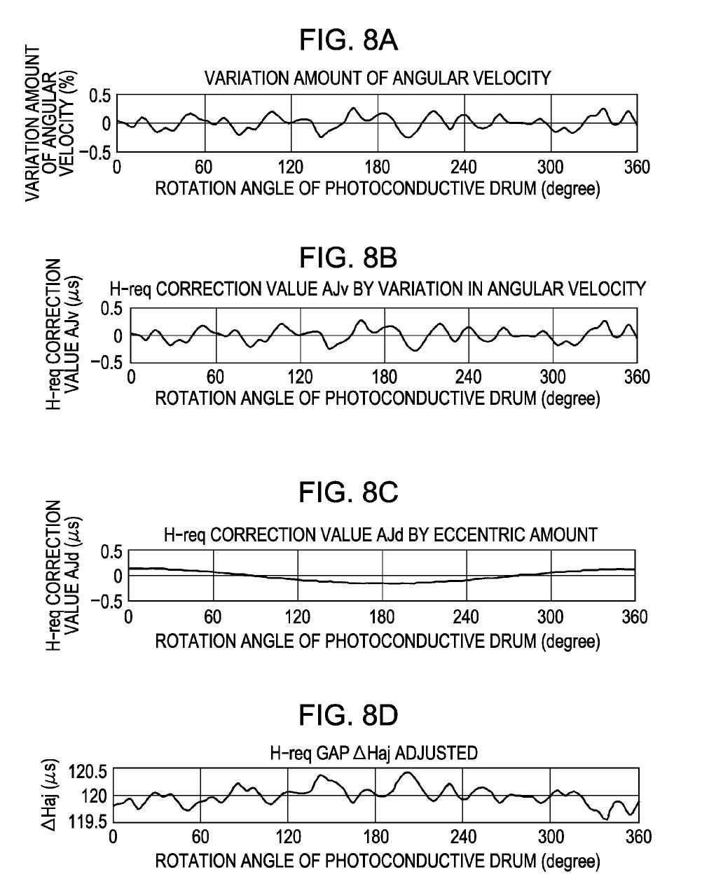

FIGS. 8A to 8D are diagrams illustrating an operation of correcting a horizontal request signal. FIGS. 8A to 8D show a case where a reference H-req interval ΔHst is 120 (μs), the radius of the photoconductive drum 21 is 20 (mm), and the eccentricity amount of the photoconductive drum 21 is 0.025 (mm). Here, the reference H-req interval is a time interval at which the horizontal request signal H-req which is not subjected to the correction is output. The reference H-req interval is determined in response to the resolution of an image to be formed. The eccentric amount of the photoconductive drum 21 is a distance between the center CT21 of the photoconductive drum 21 and the rotation center CTcy (see FIG. 5). The horizontal axes of FIGS. 8A to 8D represent the rotational angle θ of the photoconductive drum 21.

As shown in “variation amount of angular velocity” of FIG. 8A, the engine controller EC allows the line head 29 to perform the exposing operation (exposing step) and sequentially detects the variation in the angular velocity during the exposing operation (rotational angle detecting step). Specifically, the variation amount of the angular velocity is calculated as a ratio of the variation amount of the angular velocity with respect to an average value of the angular velocity. The engine controller EC calculates the “H-req correction value AJv by a variation in the angular velocity” from the variation amount of the angular velocity. The “H-req correction value AJv by a variation in the angular velocity” can be calculated by multiplying the variation amount of the angular velocity by the reference H-req interval ΔHst.

The engine controller EC reads the “H-req correction value AJd by an eccentric amount” from the memory MM. The “H-req correction value AJd by an eccentric amount” is calculated by multiplying a ratio of the variation amount of the circumferential velocity caused by the eccentricity occurring at the formation position (exposure position) of the spot SP with respect to the average circumferential velocity by the reference H-req interval. The “H-req correction value AJd by an eccentric amount” is calculated in advance at a time other than a time at which the exposure operation is performed, and stored in the memory MM. A value corrected by subtracting the “H-req correction value AJv by a variation in the angular velocity” and the “H-req correction value AJd by an eccentric amount” from the reference H-req interval is calculated as an H-req interval ΔHaj. The engine controller EC outputs the horizontal request signal H-req at the corrected H-req interval ΔHaj.

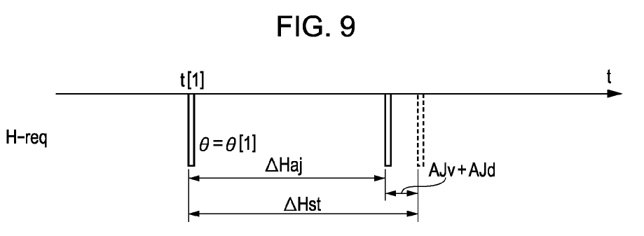

FIG. 9 is a time chart illustrating an example of the operation of correcting the horizontal request signal. In FIG. 9, the light emission element E forms the spot SP at the rotational angle θ[1] in synchronization with the horizontal request signal H-req output at time t[1]. In this case, the engine roller EC calculates the corrected H-req interval ΔHaj by subtracting the sum of the H-req correction value AJv and the H-req correction value AJd at the rotational angle θ[1] from the reference H-req interval ΔHst. The subsequent horizontal request signal H-req is output at the corrected H-req interval ΔHaj. In this embodiment, by correcting the horizontal request signal H-req in this way, the light emission time of the light emission element E is corrected. The light emission element E emits light at the corrected light emission time to the surface of the photoconductive drum 21 (exposing step).

In the image forming apparatus and the image forming method according to this embodiment, the rotational angle θ of the photoconductive drum 21 is detected. Accordingly, by correcting the light emission time on the basis of the detection result, it is possible to prevent the difference in the exposure position of the light emission element E caused due to the variation in the angular velocity of the photoconductive drum 21. However, in order to perform the good exposing operation described above, it is necessary to consider the influence of the eccentricity of the photoconductive drum 21 on the exposure position of the light emission element E. In this embodiment, the “H-req correction value AJd by an eccentric amount” used to correct the light emission time in response to the eccentricity of the photoconductive drum 21 is stored in the memory MM. In this embodiment, the emission time is corrected on the basis of the detection result of the rotational angle θ and the “H-req correction value AJd by an eccentric amount”. The light emission element E emits light at the corrected light emission time. In this way, it is possible to realize the good exposing operation by controlling the exposure position of the light emission element E with high precision without the influence of the variation in the angular velocity of the photoconductive drum 21 and the eccentricity of the photoconductive drum 21.

The method of correcting the horizontal request signal H-req on the basis of the “H-req correction value AJv by a variation in the angular velocity” and the “H-req correction value AJd by an eccentric amount” has been described, but a specific method of calculating the “H-req correction value AJd by an eccentric amount” has not been described. Hereinafter, the specific method of calculating the “H-req correction value AJd by an eccentric amount” will be described. In this embodiment, as described above, the plural photoconductive drums 21 are provided to correspond to plural colors. However, the method of calculating the “H-req correction value AJd by an eccentric amount” is the same in all of the photoconductive drums 21. Hereinafter, the method of calculating the “H-req correction value AJd by an eccentric amount” will be described using one photoconductive drum 21 representatively.

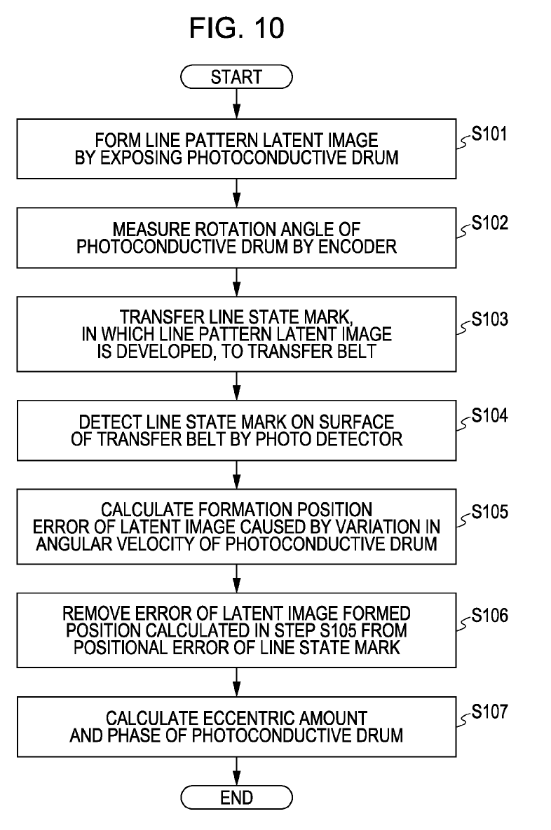

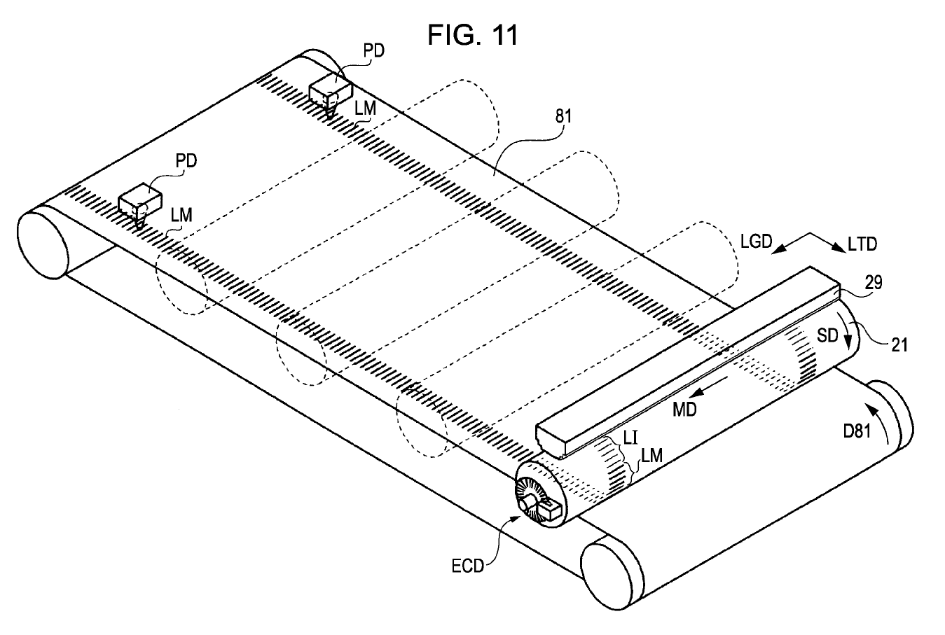

When the “H-req correction value AJd by an eccentric amount” is calculated, plural line pattern toner images LM are formed on the surface of the transfer 81 and a photo director PD detects each line pattern toner image LM. The engine controller EC calculates the eccentric amount of the photoconductive drum 21 and phase from the position of each line pattern toner image LM obtained from the detection result of the photo director PD. The “H-req correction value AJd by an eccentric amount” is calculated from the eccentric amount and the phase. The description will be made with reference to FIGS. 10 and 11.

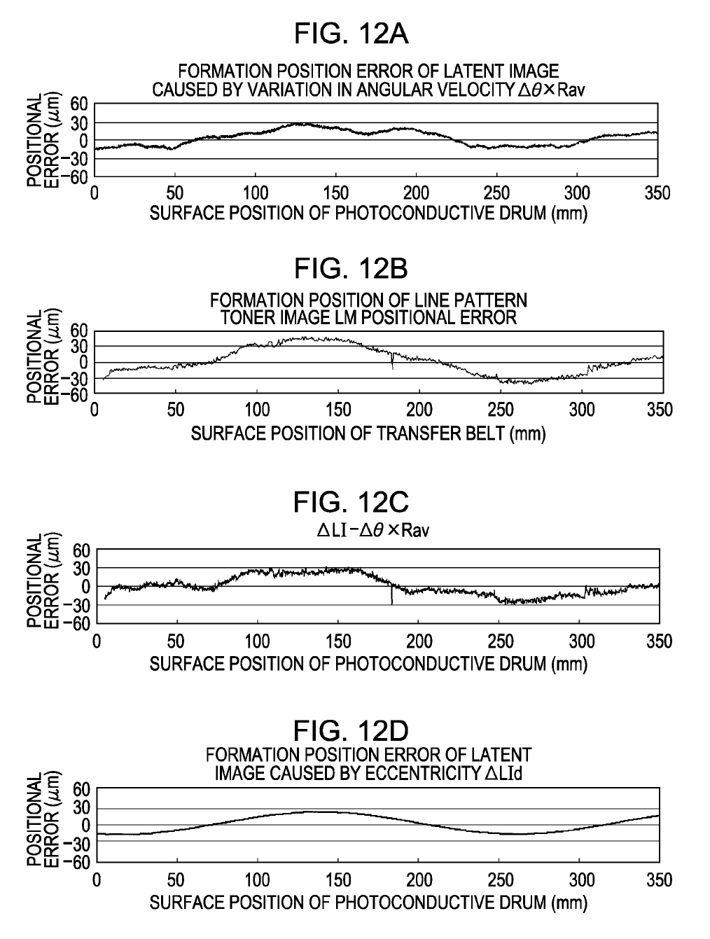

FIG. 10 is a flowchart illustrating the method of calculating the “H-req correction value AJd by an eccentric amount”. FIG. 11 is a perspective view illustrating the operation performed in the flowchart of FIG. 10. FIGS. 12A to 12D are diagrams illustrating an example of each value calculated in the operation performed in the flowchart of FIG. 10. The operation performed in the flowchart of the drawing is performed under the control of the engine controller EC.

First, by exposing the surface of the photoconductive drum 21 moving in the sub-scanning direction SD by the line head 29, plural line pattern latent images LI are formed at a predetermined time interval (step S101). The line pattern latent images LI are long in the main scanning direction MD and are substantially a rectangle. The engine controller EC detects the rotational angle θ of the photoconductive drum 21 from the output of the encoder ECD, while performing the exposing operation in step S101 (step S102). Specifically, the engine controller EC detects the rotational angle θ and time when each line pattern latent image LI is formed, and records the rotational angle θ and the time. In addition, in step S101, the line pattern latent images LI are formed during a period equal to or longer than a period during which the photoconductive drum 21 rotates once.

The plural line pattern latent images LI formed at the predetermined time interval are toner-developed, and the plural line pattern toner images LM are formed so as to be separated from each other on the surface of the photoconductive drum 21. In FIG. 11, a developer configured to develop toner is not illustrated. Each line pattern toner image LM is subjected to first transferring to the surface of the transfer belt 81 (step S103). In this way, the plural line pattern toner images LM are formed on the surface of the transfer belt 81 so as to be separated from each other in the sub-scanning direction SD (the transport direction D81 of the transfer belt 81) and the line pattern toner images LM are transported in the direction D81 with the movement of the surface of the transfer belt 81. Then, the photo director PD detects each line pattern toner image LM (step S104).

The line pattern toner images LM are detected, and the engine controller EC calculates a formation position error of a latent image caused due to the variation in the angular velocity of the photoconductive drum 21 from the rotational angle θ measured in step S102 (step S105). Specifically, an ideal angle is calculated from the measured rotational angle θ. A rotational angle error Δθ of the photoconductive drum 21 at time t at which the rotational angle θ is measured is calculated. The ideal angle is a rotational angle of the photoconductive drum 21 rotated at an average angular velocity at time t without the variation in the angular velocity and is calculated arithmetically. The rotational angle error Δθ is converted to a length unit on the surface of the photoconductive drum 21 by multiplying the rotational angle error Δθ by an average radius Rav of the photoconductive drum 21. In this way, the formation position error (Δθ×Rav) of the latent image occurring due to the variation in the angular velocity of the photoconductive drum 21 is calculated (see FIG. 12A).

Subsequently, when the photo director PD detects the line pattern toner image LM in step S104, an average transport speed of the transfer belt 81 is multiplied to calculate the absolute position of the line pattern toner image LM (step S106). An ideal position of the line pattern toner image LM is calculated from the absolute position of the line pattern toner image LM and a formation position error of the line pattern toner image LM on the surface of the transfer belt 81 in the sub-scanning direction SD is calculated (see FIG. 12B). The ideal position of the line pattern toner image LM is the position of the line pattern toner image LM formed by an ideal photoconductive drum 21 of which the circumferential velocity does not vary due to the eccentricity and the variation in the angular velocity and is calculated arithmetically. A formation position error ΔLI of each line pattern latent image LI on the surface of the photoconductive drum 21 is calculated from the formation position error of each line pattern toner image LM in the sub-scanning direction SD on the surface of the transfer belt 81. At this time, when there is a difference between the movement speed of the surface of the transfer belt 81 and the movement speed of the surface of the photoconductive drum 21, the formation position error ΔLI of each line pattern latent image LI is calculated in consideration of this difference. The formation position error (Δθ×Rav) of the latent image caused due to the variation in the angular velocity of the photoconductive drum 21 is calculated from the formation position error ΔLI of each line pattern latent image LI (see FIG. 12C).

Subsequently, in step S107, the engine controller EC extracts a component of the period of the photoconductive drum 21 from the calculation result (=ΔLI−Δθ×Rav) in step S106 by the Fourier analysis and calculates a formation position error ΔLId of the latent image caused due to the eccentricity of the photoconductive drum 21. The amount and phase of the eccentricity of the photoconductive drum 21 is calculated from the formation position error ΔLId. The variation amount of the circumferential velocity caused due to the eccentricity occurring at the position (exposure position) where the spot SP is formed is calculated from the eccentricity and the phase. The “H-req correction value AJd by an eccentric amount” is calculated by multiplying the ratio of the variation amount of the circumferential velocity by the reference H-req interval.

In this embodiment, as described above, the line pattern latent images LI are formed at the time interval on the surface of the photoconductive drum 21 rotatably driven (step S101) and the formation position error ΔLI of each line pattern latent image LI is calculated (step S104). Then, the formation position error ΔLId caused due to the eccentricity of the photoconductive drum 21 is calculated on the basis of the formation position error ΔLI of the line pattern latent image LI. In step S101, however, each line pattern latent image LI is formed with both the formation position error ΔLId caused due to the eccentricity of the photoconductive drum 21 and the formation position error Δθ×Rav caused due to the variation in the angular velocity of the photoconductive drum 21. Accordingly, the formation position error ΔLI of the line pattern latent image LI contains the formation position error ΔLId caused due to the eccentricity of the photoconductive drum 21 and the formation position error Δθ×Rav caused due to the variation in the angular velocity of the photoconductive drum 21. In this embodiment, the line pattern latent images LI are formed at the time interval on the surface of the photoconductive drum 21, while the rotational angle θ of the photoconductive drum 21 is detected (step S102). Subsequently, the formation position error ΔLI of the line pattern latent image LI caused due to the variation in the angular velocity of the photoconductive drum 21 calculated from the detection result of the rotational angle θ of the photoconductive drum 21 is removed from the error ΔLI of the line pattern latent image LI calculated in step S104. In this way, the formation position error ΔLId of the latent image caused due to the eccentricity of the photoconductive drum 21 can be calculated.

In this embodiment, by extracting the component of the period of the photoconductive drum 21 from the calculation result (=ΔLI−Δθ×Rav) in step S106, the formation position error ΔLId of the latent image caused due to the eccentricity of the photoconductive drum 21 is calculated. Therefore, the corresponding formation position error ΔLI can be calculated with high precision.

The configuration according to this embodiment is particularly suitable to a case where it is difficult to directly detect the formation position of the line pattern latent image LI from the line pattern latent image LI itself. That is, in this embodiment, the formation position of the line pattern latent image LI is detected from the position of the line pattern toner image LM formed by toner-developing the line pattern latent image LI. More specifically, the formation position of the line pattern latent image LI is detected from the position of the line pattern toner image LM transferred from the photoconductive drum 21 to the transfer belt. Accordingly, it is possible to simply detect the formation position of the line pattern latent image LI.

In this embodiment, the photoconductive drum 21 corresponds to a “latent image carrier” according to the invention. The line head 29 corresponds to an “exposure head” according to the invention. The driving motor DM corresponds to a “driver” according to the invention. The engine controller EC corresponds to a “light emission controller” according to the invention. The encoder ECD and the engine controller EC correspond to a “rotational angle detector” according to the invention. The “H-req correction value AJd by an eccentric amount” corresponds to “first light emission time correction information” according to the invention. The memory MM corresponds to a “memory” according to the invention. The “H-req correction value AJv by a variation in the angular velocity” corresponds to “second light emission time correction information” according to the invention. The drum rotational shaft AR21 corresponds to a “rotational shaft” according to the invention.

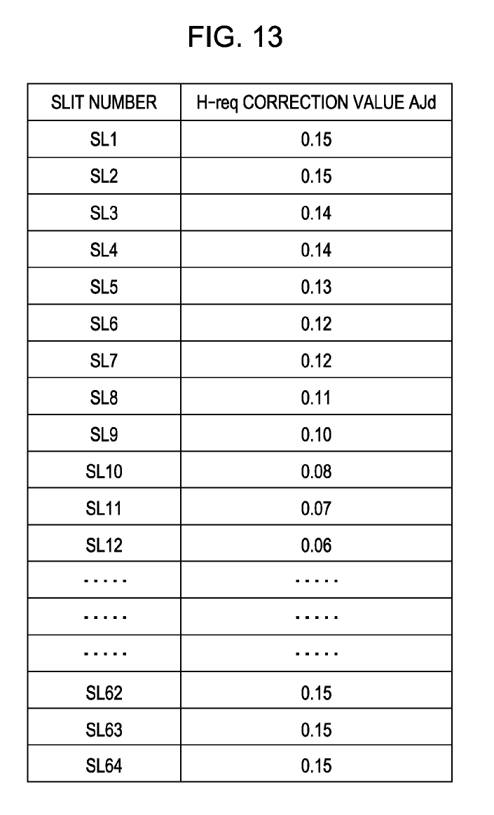

The invention is not limited to the above-described embodiment, but may be modified in various forms without departing from the gist of the invention. For example, in the above-described embodiment, the “H-req correction value AJd by an eccentric amount” is associated with the rotational angle θ of the photoconductive drum to be stored in the memory MM. However, the “H-req correction value AJd by an eccentric amount” may be associated with the number of the slit SL of the encoder ECD to be stored in a table format in the memory MM (see FIG. 13). FIG. 13 is a table illustrating a table of the “H-req correction value AJd by an eccentric amount” according to a modified example. The light emission time is controlled on the basis of the table as follows. That is, the horizontal request signal H-req may be corrected using the H-req correction value AJd (=0.15 μs) corresponding to the slit SL1, until the slit SL2 is detected after the detection of the slit SL1. In this way, the horizontal request signal H-req may also be corrected using the H-req correction value AJd corresponding to the slit number, when the other slits SL are detected.

In the above-described embodiment, the “H-req correction value AJd by an eccentric amount” is stored in the memory MM. However, the “H-req correction value AJd by an eccentric amount” may be stored in another memory element. For example, the “H-req correction value AJd by an eccentric amount” may be stored in a non-volatile memory disposed in a cartridge detachably mounted in the main body of the above-described image forming apparatus. In this case, the following advantages may be obtained. That is, in this configuration, the cartridge is replaced, as necessary, to maintain the image forming apparatus. When the photoconductive drum 21 is replaced with a new photoconductive drum in the replacement of the cartridge, it is necessary to make the “H-req correction value AJd by an eccentric amount” correspond to the eccentricity of the new photoconductive drum 21. In this case, the “H-req correction value AJd by an eccentric amount” corresponding to the eccentricity of the photoconductive drum 21 in shipment of a cartridge from a factory may be stored in a non-volatile memory. Then, when the photoconductive drum 21 is replaced with a new photoconductive drum 21 in the replacement of a cartridge, the “H-req correction value AJd by an eccentric amount” can be adjusted to a value corresponding to the replaced photoconductive drum 21. That is, even when extra work is not carried out in the replacement of the cartridge, the “H-req correction value AJd by an eccentric amount” can be normally adjusted to an appropriate value, thereby realizing an appropriate configuration.

In step S101 shown in FIG. 10, the line pattern latent images LI are formed during a period equal to or longer than a period during which the photoconductive drum 21 rotates once. However, the period during which the line pattern latent images LI are formed is not limited thereto. For example, the line pattern latent images LI may be formed during five times or more a period during which the photoconductive drum 21 rotates once. With such a configuration, the formation position error of the line pattern latent image LI caused due to the eccentricity of the photoconductive drum 21 can be calculated with high precision.

In the above-described embodiment, the plural light emission elements E are arranged in a straight line in the longitudinal direction LGD. However, the plural light emission elements E may be arranged in two zigzag lines or in three zigzag lines.

In the above-described embodiment, an organic EL element is used as the light emission element E. However, an LED (Light-Emitting Diode) may be used as the light emission element E.

The configuration of the line head 29 is not limited to the above described configuration. For example, a line head 29 described in JP-A-2008-036937 or JP-A-2008-036939, for example, may be used. However, in the line head 29 described in JP-A-2008-036937 or JP-A-2008-036939, plural light emission elements are arranged in zigzags to form one light emission element group and plural light emission element groups may be arranged two-dimensionally. Therefore, the plural light emission elements are arranged at different positions in the sub-scanning direction SD. For example, in the line head 29, as described in FIG. 11 in JP-A-2008-036937, light emission of the light emission elements arranged at the different positions in the sub-scanning direction SD is controlled at different light emission times. When the invention is applied to such a line head 29, the horizontal request signal H-req may be disposed in each of the plural light emission elements arranged at the different positions in the sub-scanning direction SD. Each horizontal request signal H-req may be corrected in response to the variation in the angular velocity or the eccentricity of the photoconductive drum 21.

In the above-described embodiment, the rotational shaft AR21 of each photoconductive drum 21 is rotatably driven directly by each exclusive-use driving motor DM. However, a driving force transfer system such as a gear may be installed between the rotational shaft AR21 and the driving motor DM.

### Example

Next, an example of the invention will be described. However, the invention is not limited to the following example, but may, of course, be modified appropriately in various forms without departing from the gist of the invention and the modifications are all included in the technical scope of the invention.

According to the following example, there is obtained an advantage of correcting the horizontal request signal H-req on the basis of the “H-req correction value AJd by an eccentric amount”. Accordingly, a case where the horizontal request signal H-req is corrected on the basis of only the “H-req correction value AJv by a variation in the angular velocity” will be compared to a case where the horizontal request signal H-req is corrected on the basis of both the “H-req correction value AJv by a variation in the angular velocity” and the “H-req correction value AJd by an eccentric amount”.

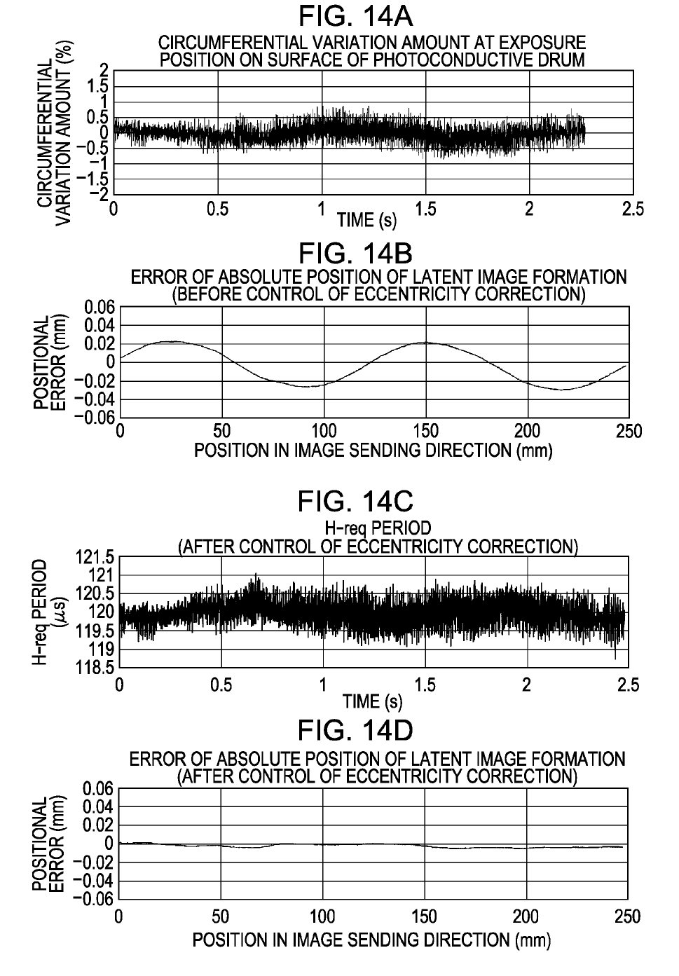

FIGS. 14A to 14D are diagrams illustrating an example of the invention. In this example, a graph of FIG. 14A shows that the variation in the circumferential velocity occurs in the photoconductive drum 21. The variation amount of the circumferential velocity refers to a variation amount of the circumferential velocity at the exposure position on the surface of the photoconductive drum 21. As known from the graph of FIG. 14A, there are a variation in a very short period viewed like a needle and a variation in a relatively long period in second order. The variation in the very short period is mainly caused by the variation in the angular velocity of the photoconductive drum 21. The variation in the long period is mainly caused by the eccentricity of the photoconductive drum 21.

A graph of FIG. 14B shows a formation position error of a latent image in the case where the horizontal request signal H-req is corrected on the basis of only the “H-req correction value AJv by a variation in the angular velocity”. Here, the formation position error of a latent image occurs sinusoidally, since the correction (eccentricity correction control) of the horizontal request signal H-req is not formed on the basis of the “H-req correction value AJd by an eccentric amount”.

A graph of FIG. 14C shows the period of the horizontal request signal H-req corrected on the basis of both the “H-req correction value AJv by a variation in the angular velocity” and the “H-req correction value AJd by an eccentric amount”. A graph of FIG. 14D shows the result when the light emission element emits light in synchronization with the corrected horizontal request signal H-req. In comparison to the graph of FIG. 14B, the graph of FIG. 14D shows that the formation position error of a latent image is considerably inhibited.

The entire disclosure of Japanese Patent Application No: 2008-333115, filed Dec. 26, 2008 is expressly incorporated by reference herein.

What is claimed is:

1. An image forming apparatus comprising:
a latent image carrier that carries a latent image;
an exposure head that forms a latent image to emit light from a light emitting element;
a driver that rotationally drives the latent image carrier;
a light emission controller that controls light emission time of the light emitting element;
a rotational angle detector that detects a rotational angle of the latent image carrier; and
a memory that stores first light emission time correction information to correct the light emission time in response to an eccentricity of the latent image carrier,
wherein the light emission controller permits the light emitting element to emit light at the light emission time corrected on the basis of a detection result of the rotational angle detector and the first light emission time correction information.

2. The image forming apparatus according to claim 1, wherein the light emission controller obtains second light emission correction information to correct the light emission time from the detection result of the rotational angle detector in response to a variation in the angular velocity of the latent image carrier, and corrects the light emission time on the basis of the first light emission time correction information and the second light emission time correction information.

3. The image forming apparatus according to claim 1, wherein the latent image carrier is a photoconductive drum having a rotational shaft, and the driver rotationally drives the rotational shaft.

4. The image forming apparatus according to claim 3, wherein the rotational angle detector is an encoder disposed on the rotational shaft of the photoconductive drum.

5. The image forming apparatus according to claim 3, wherein the memory is disposed in a cartridge that is detachably mounted in the image forming apparatus and holds the photoconductive drum.

6. The image forming apparatus according to claim 5, wherein the memory is a non-volatile memory.

7. An image forming method comprising:
detecting a rotation angle of a latent image carrier that is rotationally driven; and
forming a latent image to emit light from a light emitting element,
wherein the exposing includes reading from a memory first light emission time correction information to correct light emission time in response to an eccentricity of the latent image carrier, and permitting the light emitting element to emit light at the light emission time corrected on the basis of a detection result from the detecting of the rotation angle and the first light emission time correction information.
